(19) United States
(12) Patent Application Publication
(10) Pub. No.: US 2014/0052989 A1
(43) Pub. Date: Feb. 20, 2014

(54) SECURE DATA EXCHANGE USING MESSAGING SERVICE

(71) Applicants: Austin Jones, Ashburn, VA (US); Dennis Hostetler, Westminster, MD (US); Michael Reichle, Mount Airy, MD (US)

(72) Inventors: Austin Jones, Ashburn, VA (US); Dennis Hostetler, Westminster, MD (US); Michael Reichle, Mount Airy, MD (US)

(73) Assignee: Ultra Electronics, ProLogic, Manassas, VA (US)

(21) Appl. No.: 13/586,487

(22) Filed: Aug. 15, 2012

(51) Int. Cl. H04L 9/00

(52) U.S. Cl. 713/171

(57) ABSTRACT

A system for securely communicating over a network includes a sending device and a receiving device. The sending device includes first processing hardware configured to encrypt a symmetric key associated with the sending device with a public key associated with a receiving device. The first processing hardware is further configured to steganographically embed the symmetric key into an image. The sending device further includes a first signal interface configured to send the image to the receiving device. The receiving device includes second signal interface for receiving the image from the sending device. The receiving device also includes second processing hardware configured to decrypt the symmetric key with a private key stored on the receiving device and to further secure communications with the sender via the symmetric key.

### FIELD OF THE INVENTION

The present invention relates to systems and methods for sending and receiving secure messages, and, more particularly, to systems and methods for sending and receiving secure messages using encryption keys for establishing and maintaining a secure communication via a messaging service.

### BACKGROUND OF THE INVENTION

Consumers throughout the world utilize electronic communications to send and receive information, both for purely social and for work-related purposes. Information is passed via various communication channels, including instant messaging, text messaging, picture messaging, voicemail, email, via social networks, and others. Security and confidentiality of information is a key concern for many consumers.

A wide variety of social networks, including TWITTER, FACEBOOK, LINKED IN, FOURSQUARE, etc. exist. The social networks have a growing population of end-users, with each network claiming several hundreds of millions of users throughout the world. A majority of internet users use one or more type of social networks. The social networks are readily accessible from a wide variety of portals with internet access including personal computers, laptops, smartphones, gaming systems, PDAs, tablets, etc. Access to such sites is generally available free of charge to any user that fills out a simple registration form. Depending on the type of social network and an individual user's privacy setting, a communication sent by a user of such social networking sites may reach either a very large (e.g., millions of people) or a very small (e.g., a few people) audience. The social networks generally also allow for private communications between users. Many companies also establish their own private social networks to facilitate communication and transmission of information between employees.

Social networks are commonly used to transmit various types of information, including text, pictures, or videos. The transmission of information is instantaneous. Moreover, depending on the social network, other users may receive instant notification about another user's transmission. One drawback of information transmission via social networks is that the amount or type of information transmitted may be limited by the particular social network. For example, TWITTER currently limits users' text transmissions to 140 characters. A further drawback is censorship of information transmitted on the social networks by certain governments. For example, certain governments could scan messages for certain words, or could completely or partially block certain social networks.

### SUMMARY OF THE INVENTION

The present invention relates to systems and methods for sending and receiving secure messages or communications using encryption keys for establishing and maintaining a secure communication via a messaging service. For example, an embodiment may relate to a microblogging service that uses encryption technologies to enable private communications. The private communications may take place between two users, or between a user and a group or several groups. Embodiments may relate to an end-to-end social networking service for commercial and government entities, allowing organizations to send and receive private messages or communications using encryption and decryption techniques. Such embodiments allow members of a mobile workforce to share information and files confidentially no matter where they are, while knowing that only the intended recipients can open the communication and the privacy and security of the communication will not be compromised during the transmission or afterwards.

One aspect of the present invention relates to a receiving device for receiving secure communications including a signal interface and processing hardware. The signal interface is configured to receive an image. The image includes a steganographically embedded symmetric key from the sender. The symmetric key is encrypted with a public key associated with the receiving device. The processing hardware is configured to decrypt the symmetric key with a private key stored on the receiving device and to further secure communications with the sender via the symmetric key. The processing hardware is configured to encrypt future communications from the receiving device using the symmetric key. In a further aspect of the present invention, the receiving device includes a user interface for communicating subsequent decrypted communications to a user of the receiving device.

A further aspect of the present invention relates to a sending device including processing hardware and a signal interface. The processing hardware is configured to encrypt a symmetric key associated with the sending device with a public key associated with the receiving device and to steganographically embed the symmetric key into an image. The signal interface is configured to send the image to the receiving device, wherein the symmetric key is decryptable by a private key associated with the receiving device.

In a further aspect of the present invention, the receiving device includes a second image associated therewith. The second image includes the public key steganographically embedded into the second image. The processing hardware of the sending device is configured to retrieve the public key from the second image.

Yet another aspect of the present invention relates to a system for securely communicating over a network. The system includes a sending device and a receiving device. The sending device includes first processing hardware configured to encrypt a symmetric key associated with the sending device with a public key associated with a receiving device. The first processing hardware is further configured to steganographically embed the symmetric key into an image. The sending device further includes a first signal interface configured to send the image to the receiving device. The receiving device includes second signal interface for receiving the image from the sending device. The receiving device also includes second processing hardware configured to decrypt the symmetric key with a private key stored on the receiving device and to further secure communications with the sender via the symmetric key.

A further aspect of the present invention relates to a method of securely communicating over an unsecure network. The method includes receiving an image from a sender by a signal interface of a receiving device. The image includes a steganographically embedded symmetric key from the sender. The symmetric key is encrypted with a public key associated with the receiving device. Processing hardware of the receiving device decrypts the symmetric key via a private key stored on the receiving device. The processing hardware further secures communications with the sender via the symmetric key.

Another aspect of the present invention relates to a method of securely communicating over an unsecure network. The method includes encrypting, by processing hardware of a sending device, a symmetric key associated with the sending device with a public key associated with a receiving device. The processing hardware steganographically embeds the symmetric key into an image. A signal interface of the sending device sends the image to the receiving device. The symmetric key is decryptable by a private key associated with the receiving device.

Yet another aspect of the present invention relates to a system for securely communicating in a network. The system includes a sending device and a receiving device. The sending device includes first processing hardware configured to encrypt a symmetric key associated with the sending device with a public key associated with a receiving device. The sending device additionally includes a first signal interface configured to send the encrypted symmetric key to the receiving device. The receiving device includes a second signal interface for receiving the encrypted symmetric key from the sending device. The receiving device additionally includes second processing hardware configured to decrypt the symmetric key with a private key stored on the receiving device and to further secure communications with the sender via the symmetric key.

### BRIEF DESCRIPTION OF THE DRAWINGS

The foregoing and other advantages of the present disclosure will become apparent upon reading the following detailed description and upon reference to the drawings.

FIG. 1A is a system for establishing secure communications in a network;

FIG. 1B is another aspect of the system for establishing secure communications in a network;

FIG. 1C is another aspect of the system for establishing secure communications in a network;

FIG. 2 is a flowchart illustrating the key exchange process between two devices in a network;

FIG. 3 is a system illustrating a symmetric key subscription service;

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF ILLUSTRATED EMBODIMENTS

In the following description, for purposes of explanation and not limitation, specific details are set forth, such as particular embodiments, procedures, techniques, etc. in order to provide a thorough understanding of the present invention. However, it will be apparent to those ordinarily skilled in the art that the present invention may be practiced in other embodiments that depart from these specific details.

One aspect of the present invention relates to a system for establishing secure communications that is compatible with a variety of mobile and non-mobile platforms, including BLACKBERRY, APPLE iOS, ANDROID, MICROSOFT (WINDOWS), Web, and other platforms. The system is a microblogging service that allows users to communicate and transmit information securely and confidentially. The system allows for secure and confidential transmission of text messages and files, including images, video, voicemail, and other information. The system is accessible from any device that can be connected to the Internet, including a computer, a portable game console, a mobile device such as a smartphone, a personal digital assistant, a tablet, and the like. One aspect of the present invention allows for the data that is present on a mobile device utilizing the system to be synchronized with the data present on the other devices, such as tablets, computers, and the like.

The system or application for establishing secure communications may be downloaded onto a device, such as a smartphone or a tablet, from an application store, such as GOOGLE PLAY, APPLE APP STORE, or the like. According to a further aspect of the present invention, the application may be an enterprise application that is hosted on a server or cloud network. Each authorized user downloads an application onto his or her device to enable secure communications with the other enterprise application users.

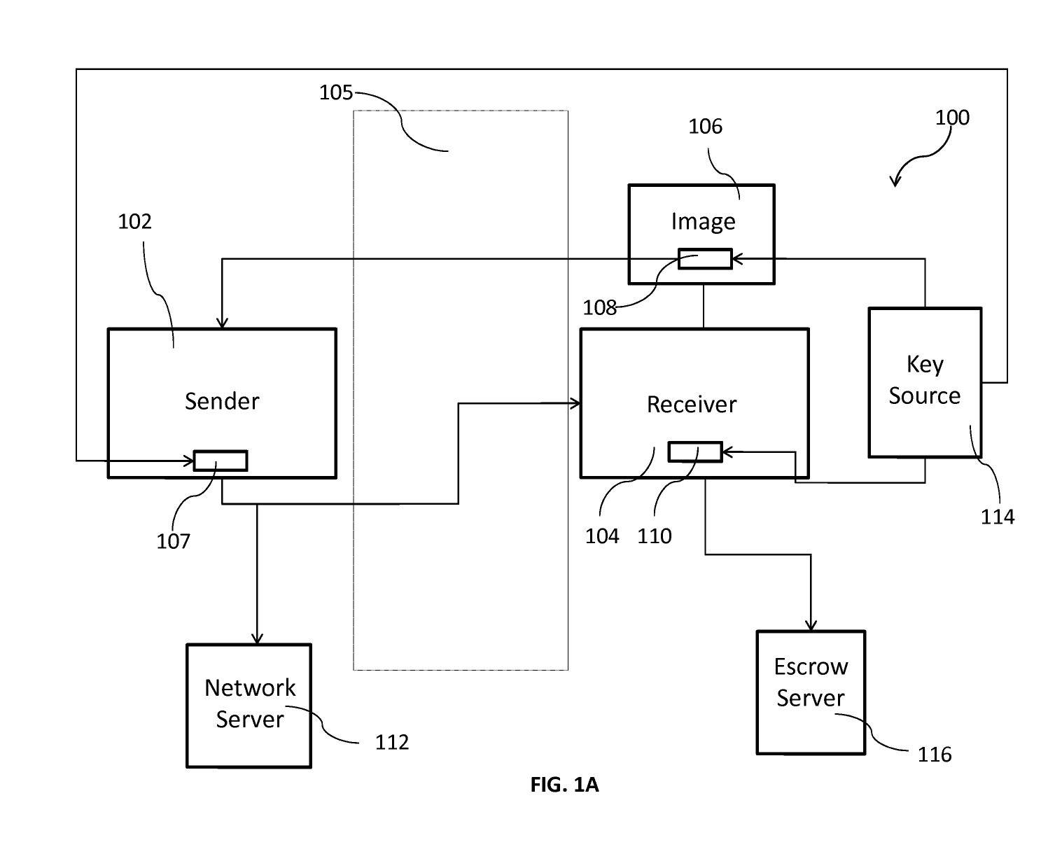

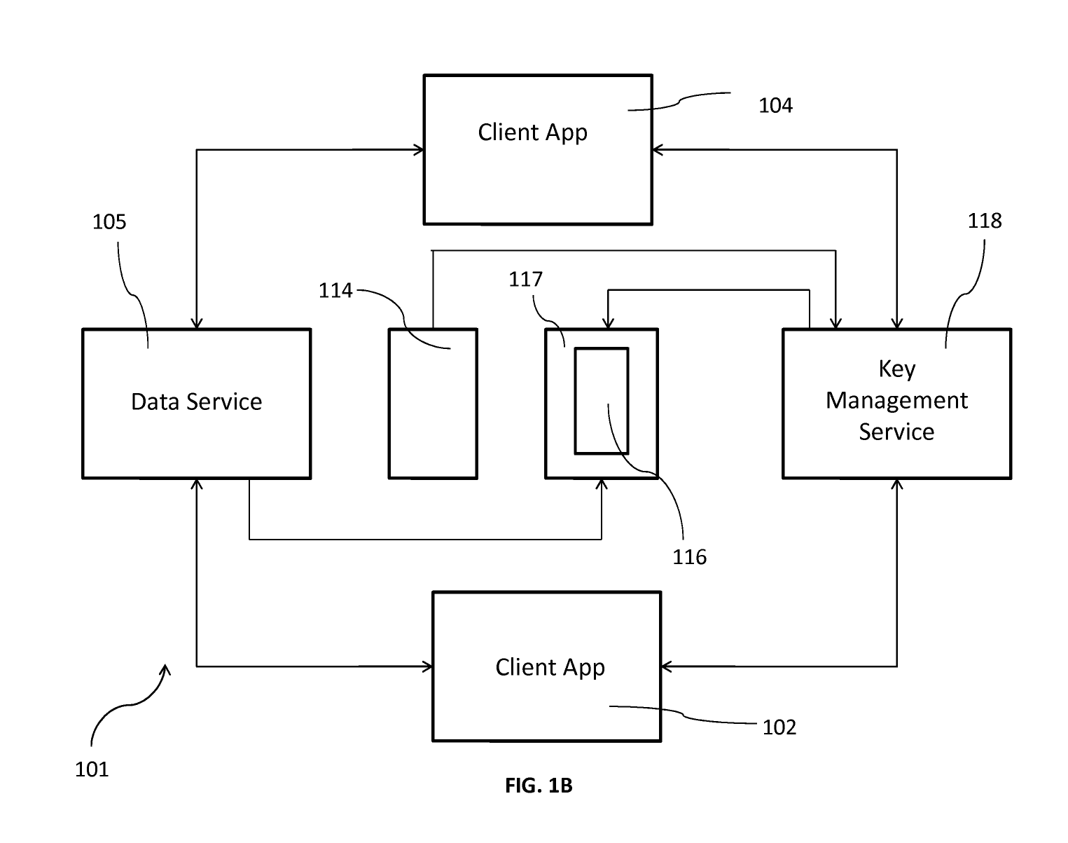

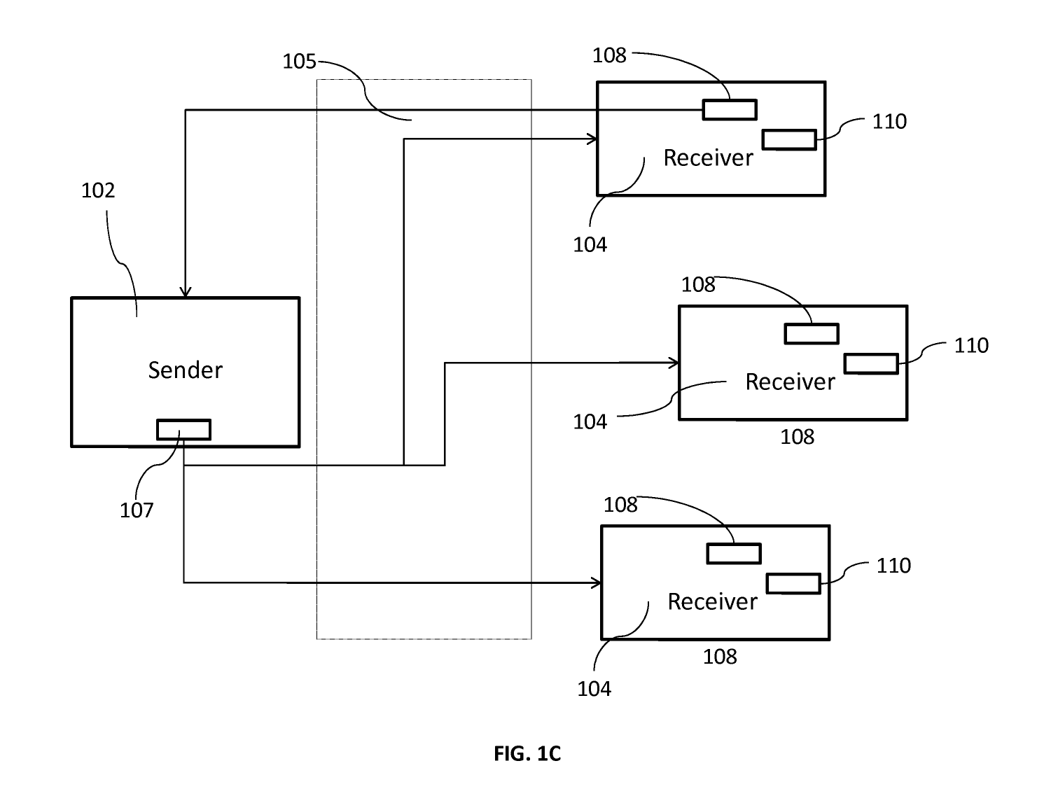

FIG. 1A illustrates a system 100 for establishing secure communications including a sender 102 and a receiver 104. Each one of the sender 102 and the receiver 104 has a user account associated therewith. The system for establishing secure communications may include several receivers 104 as shown in FIG. 1C. The user accounts may be accessed from a variety of devices, including mobile devices such as smartphones, portable digital assistants, tablets, computers, portable game consoles and other devices capable of sending and receiving messages.

The devices 102 and 104 communicate through a social networking service or infrastructure, including, but not limited to, TWITTER, YAMMER, E-CHIRP, FACEBOOK, HANDSHAKE, other third-party social networks, private social networks, and the like. According to a further aspect of the present invention, devices 102 and 104 communicate through a variety of different services and servers, including social networking services (such as TWITTER, FACEBOOK, YAMMER, or the like), private enterprise servers, instant messaging services, text messaging services, email servers (private and public), and the like. The system 100 is configured to integrate with any third party social networking service. Accordingly, organizations that already have operational social networks in place can add to such social networks the private messaging capability described in the present invention. In turn, this saves the organizations time and money as they do not have to establish new communication networks in order to have secure and confidential messaging capabilities.

The sender 102 includes a symmetric key 107 associated therewith. The receiver 104 includes a public key 108 and a private key 110 associated therewith. According to one embodiment of the present invention, the sender 102 includes processing hardware configured to generate the symmetric key 107, and the receiver 104 includes processing hardware configured to generate the public key 108 and the private key 110. In this case, the sender 102 and the receiver 104 do not have access to and/or are not coupled to a key source.

Alternatively, according to a second embodiment of the present invention, each one of the sender 102 and the receiver 104 is coupled to a key source 114. The sender 102 includes a public key and a private key associated therewith. The sender 102 includes processing hardware configured to generate the public key and the private key associated with the sender 102. The key source 114 obtains the public key associated with the sender 102 via any method discussed below or any known method. The key source 114 generates a symmetric key 107 for the sender 102. The key source 114 includes processing hardware configured to encrypt (or wrap) the symmetric key 107 with the public key associated with the sender 102. The key source 114 transmits the encrypted symmetric key 107 to the sender 102. The sender 102 uses the private key associated with the sender 102 to decrypt the encrypted symmetric key 107. The receiver 104 includes a public key 108 and a private key 110 associated therewith. The receiver 104 includes processing hardware configured to generate the public key 108 and the private key 110. The sender 102 obtains the public key 108 associated with the receiver 104 by any method discussed below or any known method. The sender 102 encrypts the symmetric key 107 received from the key source 114 with the public key 108 associated with the receiver 104. The sender 102 transmits the encrypted symmetric key 107 to the receiver 104. The receiver 104 uses its private key 110 to decrypt the symmetric key 107. According to another aspect of the present invention, the key source 114 obtains the public key 108 associated with the receiver 104. The key source 114 encrypts the symmetric key 107 with the public key 108 associated with the receiver 104. The key source 114 transmits the encrypted symmetric key 107 to the receiver 104. The receiver 104 uses its private key 110 to decrypt the symmetric key 107.

According to another embodiment of the present invention, each one of the sender 102 and the receiver 104 is coupled to the key source 114. The key source 114 includes processing hardware configured to generate public keys for the devices in a network or other infrastructure 105, including the sender 102 and the receiver 104. The network 105 is any infrastructure that allows users to transmit data between two or more points. The key source 114 transmits the generated public keys to the devices in the network 105 via the network 105 which may be an unsecure network. The key source 114 includes processing hardware configured to generate the symmetric key 107. The key source 114 includes processing hardware configured to encrypt the symmetric key 107 with a public key corresponding to the device in the network 105 to which the key source 114 is transmitting the encrypted symmetric key 107. Accordingly, if the key source 114 is transmitting the encrypted symmetric key 107 to the sender 102, the key source encrypts the symmetric key 107 with the public key associated with the sender 102. The sender 102 then uses a private key associated with the sender 102 to decrypt the encrypted symmetric key 107.

The key source 114 is configured to provide users with the strongest encryption technology required or needed, including encryption keys for the military, the intelligence community, or law enforcement. The key source 114 is configured to update or roll over the keys generated by the key source 114 based on a predetermined set of criteria or based on a direct request.

According to another embodiment of the present invention, the key source 114 is coupled to a key management service 118. According to this embodiment, any key generated by the key source 114 is transmitted first to the key management service 118. The key management service 118 is configured to transmit the key received from the key source 114 to the sender 102 and/or the receiver 104. The key management service 118 stores the keys and transmits them to the receiver 104 and/or the sender 102 based on a predetermined criterion or trigger or based on a specific request from the receiver and/or the sender 102. The key management service 118 is configured to send a request to the key source 114 to update or roll over the keys generated by the key source 114 based on a predetermined set of criteria or based on a direct request.

FIG. 1B illustrates a system 101 for establishing secure communications. The key management service 118 is a mechanism by which key exchanges occur between clients. The key management service 118 allows behind the scenes, safe key handling once the system 101 has been set up. The key management service 118 is configured to work with a variety of systems for enabling secure communications between devices within the network, including system 100 of FIG. 1A and system 101 of FIG. 1B. According to one aspect of the present invention, the key management service 118 is provided on a cloud or private enterprise.

Users of the systems 100 and 101 include organizations that would like to pass secure messages between employees. Such users may select an appropriate key management architecture based on their individual needs, budgets, and security requirements.

The systems 100 and 101 may be used with email, instant messaging, text messaging, Internet forums and blogs, and any other communication platforms. The systems 100 and 101 are compatible with BLACKBERRY, APPLE iOS, ANDROID, MICROSOFT (WINDOWS), Web, and other platforms. The systems 100 and 101 are configured to operate in a variety of networks, including public internet and private networks including NIPRNET, private 3G, private 4G as well as mobile and temporary networks and hotspots. The systems 100 and 101 may be integrated with a variety of technologies, including video recordings, voice recordings and memos, biometric data input or collected from phone sensors, encrypted voicemail, GPS/map data for military, recorded phone calls, sensor messages (such as SIGINT, MASINT, IMINT, GEOINT, health status/diagnostics, and others), sensor metadata, and the like.

According to one aspect of the present invention, the receiver 104 includes an image 106, such as a profile picture or other publicly available image, associated therewith. The image 106 is publicly available to anyone viewing or searching for the receiver 104's account.

The image 106 includes the public key 108 associated therewith. The public key 108 is steganographically embedded into the image 106 and may be retrieved by anyone who has access to or permission to view the image 106 associated with the receiver 104. By posting or broadcasting the image 106, the receiver 104 makes the public key 108 available to selected users or accounts. The public key 108 is embedded into the image 106 using steganography for use by any other client, user, or account who has the permission to view the image 106. According to one aspect of the present invention, the image 106 may be entirely public, and any other client, user, or account is able to view the image 106 and retrieve the steganographically embedded public key 108.

The public key 108 may be any key that is known in the art, including Public Key Infrastructure (PKI) key and others. As is known, the TWITTER service allows for transmission of messages limited to 140 characters. However, the TWITTER service allows for transmission of pictures or images of significantly larger sizes. The public key 108 is typically larger than 140 characters, and it may not be transmitted in the text of the TWEET. Accordingly, steganographially embedding the public key 108 into the image 106 allows for the sender to retrieve and use the public key 108 without the need for the receiver 104 to send the public key 108 directly to the sender 102.

According to another aspect of the present invention, the sender 102 and the receiver 104 communicate over a network 105 that allows for transmission of messages that are large enough to include the public key 108. The receiver 104 transmits the public key 108 to the sender 102 either based on a predetermined triggering criteria (e.g., time, signal, etc.) or based on a specific request from the sender 102. According to a further aspect of the present invention, the public key 108 is stored on a public or private cloud. Pre-selected users have access to the public key 108 on the public or private cloud.

The sender 102 and the receiver 104 exchange cryptographic keys in order to achieve secure communications between the sender 102 and the receiver 104. The sender 102 and the receiver 104 exchange cryptographic keys using any known suitable key exchange technique. According to one aspect of the present invention, the sender 102 and the receiver 104 utilize asymmetric key cryptography techniques (e.g., RSA), Diffie-Hellman key exchange, elliptic curve cryptography (ECC), including elliptic curve Diffie-Hellman key agreement scheme, and other suitable techniques.

According to one aspect of the present invention, the sender 102 retrieves the public key 108 from the image 106 over an unsecure network or data service 105. The sender 102 includes processing hardware that is configured to retrieve or decode the steganographically embedded public key 108. The sender 102 encrypts the symmetric key 107 using the public key 108. The encrypted symmetric key 107 may be sent to the receiving device 104 by any secondary mechanism that is distinguishable from a primary mechanism by which the actual encrypted communications between the sender 102 and the receiver 104 are sent.

According to one aspect of the present invention, the sender 102 embeds the encrypted symmetric key 107 into a second image using steganography. The second image is then transmitted by the sender 102 to the receiver 104. In a further aspect of the present invention, the second image is broadcast over the network 105. The second image including the steganographically embedded encrypted symmetric key 107 may be sent to the receiving device 104 by any secondary mechanism that is distinguishable from a primary mechanism by which the actual encrypted communications between the sender 102 and the receiver 104 are sent.

In a further aspect of the present invention, the receiver 104 transmits the public key 108 directly to the sender 102 without embedding the public key 108 into an image. The sender 102 then transmits the encrypted symmetric key 107 to the receiver 104 without embedding the encrypted symmetric key 107 into the second image. Once the receiver 104 receives and decrypts the symmetric key 107, the receiver 104 may securely communicate with other devices within the network 105 that have received or that possess the symmetric key 107 by encrypting all communications or messages from the receiver 104 with the symmetric key 107. Other devices in the network 105 that receive and decrypt the symmetric key 107 may also securely communicate with the other devices in the network 106 by encrypting all outgoing communications with the symmetric key 107. The receiver 104 is also configured to transmit the symmetric key 107 to other network devices by encrypting the symmetric key 107 with the public key associated with the device receiving the symmetric key 107.

The network 105 does not have the capability to decode or decrypt the communication between the sender 102 and the receiver 104. The encryption keys are opaque to the network 105. The network 105 only sees the encrypted communications.

According to one aspect of the present invention, only users that know the symmetric key 107 can encrypt the communications between the sender 102 and the receiver 104 (or between other devices in the network communicating by encrypting their messages with the symmetric key 107) that are encrypted with the symmetric key 107. The communication between the sender 102 and the receiver 104 in step 208 is set up in such a way that the network within which the communication takes place (e.g., a third party social network, such as TWITTER or a private enterprise network) is unable to decrypt the communication. The communication between the sender 102 and the receiver 104 appears to the network to be an encrypted communication. The network 105 only sees the encrypted (e.g., cyphertext) transmission between the sender 102 and the receiver 104. The network 105 cannot see the communication that is encrypted within the transmission from the sender 102 to the receiver 104 in step 210 or in further communications encrypted with the symmetric key 107 between other devices within the network 105. The encrypted transmission also appears as an encrypted transmission to third parties. Moreover, the network 105 or third parties (unless specifically authorized by receiving the symmetric key 107 from the sender 102 or from another device) are unable to decrypt the encrypted communication between the sender 102 and the receiver 104 as they do not possess the symmetric key 107.

In turn, this prevents the persistent problem of security breaches. Commercial messaging and social networking services typically lack security measures for transmitting messages. Messages are susceptible to being monitored, intercepted, or otherwise read by third parties. One aspect of the present invention relates to achieving and ensuring that private, confidential messages can only be delivered to the intended recipients and/or their devices. Since no third party or network possesses the capability to decrypt the encrypted communication, this eliminates the problem that occurs when the network's security is compromised, such as when a hacker or another unauthorized user unlawfully gains access to the network's secure data. According to one aspect of the present invention, even if such an unauthorized user were able to gain access to the network's secure data, they would be unable to access the encrypted communication, as the communication may only be decrypted by those users that possess the symmetric key 107. This also allows users to securely transmit messages without fear of censorship (by a government or otherwise) and communication interception. Server cooperation is not required or needed.

Some networks, email servers, messaging servers, or third party social networking services store all communications between users. Such messages may be stored on a server 112 (e.g., network server) associated with the network 105. The server 112 hosts all social networking and microblogging data, including messages, files, images, etc. Since the network 105 cannot decrypt the messages communicated between the sender 102 and the receiver 104, any messages stored on the server 112 are stored in encrypted form. In other words, once these messages are stored on the server 112, they may not be decrypted by anyone because the keys used to encrypt the message are not stored with the encrypted message. The network 105 only sees and stores the encrypted messages and cannot see the keys transmitted with these messages. Accordingly, if someone intercepted the transmission between the sender 102 and the receiver 104 or if someone gained access to the contents of the server 112, they could only see the encrypted messages and would not have access to the keys needed to decode these messages. Even network administrators may not gain access to the decrypted messages.

The receiver 104 receives the encrypted message from the sender 102. The receiver 104 decodes or decrypts the symmetric key 107 using the private key 110. According to one aspect of the present invention, the decrypted message and the symmetric key are stored on an escrow server 116 to comply with government and enterprise record retention policies. The escrow server 116 is not accessible from the internet, which improves the security of the system 100.

The escrow server 116 stores both the keys and the messages between the sender 102 and the receiver 104 or other devices within the network 105. According to one aspect of the present invention, the escrow server 116 receives the message through the network 105 into the escrow server 116 using either a Data Diode cable, or a Cross Domain Solution (CDS). The Data Diode cable and the CDS are devices configured to ensure that unencrypted messages cannot get back out to the network 105. The escrow server 116 decrypts the encrypted message from the network 105 with the retrieved symmetric key 107. The escrow server 116 then stores the decrypted message. According to one aspect of the present invention, the escrow server 116 connects to the network through the Data Diode cable or the CDS. The escrow server 116 may be coupled to a pre-escrow server (not shown). The pre-escrow server is configured to retrieve messages from the network 105 and send those messages through the Data Diode or the CDS to the escrow server 116. According to a further aspect of the present invention, the key source 114 is coupled to the Data Diode or the CDS. The key source 114 is configured to provide the symmetric key 107 in an unencrypted form to the escrow server 116.

The sender 102 and the receiver 104 utilize symmetric keys for encryption and decryption—the sender 102 encrypts the symmetric key with the receiver's public key 108 and the receiver 104 decrypts with the private key 110. Certain conventional systems use public key infrastructure (PKI) to encrypt and decrypt information. Using PKI to encrypt and decrypt places a significant strain on computational resources. Using symmetric keys solves this problem and frees up valuable computational resources. Moreover, broadcasting the public key 108 by the receiver 104 makes the public key 108 concurrently available to the entire audience selected by the receiver 104. In other words, the receiver 104 does not have to send a separate transmission to each individual account or user with the receiver 104's public key 108. Symmetric key techniques according to the present invention include Advanced Encryption Standard (AES), TWOFISH, SERPENT, BLOWFISH, CASTS, RC4, 3DES, IDEA, and others.

Referring now to FIG. 1B, a system 101 for securely communicating in a network includes a sender client application 102 and a receiver client application 104. The sender 102 and the receiver 104 communicate within a data service 105 which may be a social network, a private enterprise network, or any other network or infrastructure over which data is communicated. The data service or network 105 may be a secure or an unsecure network. The sender 102 retrieves the public key 108 associated with the receiver 104. The public key 108 may be steganographically embedded into the image 106 or it may be hosted on a public or private cloud. According to one aspect of the present invention, the receiver 104 transmits the public key 108 to the sender 102. The sender 102 encrypts the symmetric key 107 with the public key 108 associated with the receiving device 104 based on a predetermined trigger or user request. The sender 102 then transmits the encrypted message to the receiver 104 over the network or data service 105. The network or data service 105 cannot see or intercept the communication between the sender 102 and the receiver 104: the communication appears as an encrypted (e.g., cyphertext) message. The receiver 104 decrypts the symmetric key 107 with the private key 110 associated with the receiver 104 and stores the symmetric key 107 for future use. The receiver 104 uses the symmetric key 107 to encrypt future communications from the receiver 104 to devices within the network 105 possessing the symmetric key 107. The receiver 104 is configured to request to subscribe to the sender 102's symmetric keys. The key management service 118 is coupled to an escrow relay 117 that includes an escrow server 116. Decrypted messages and keys are optionally stored on the escrow server 116 to comply with government and enterprise data retention policies.

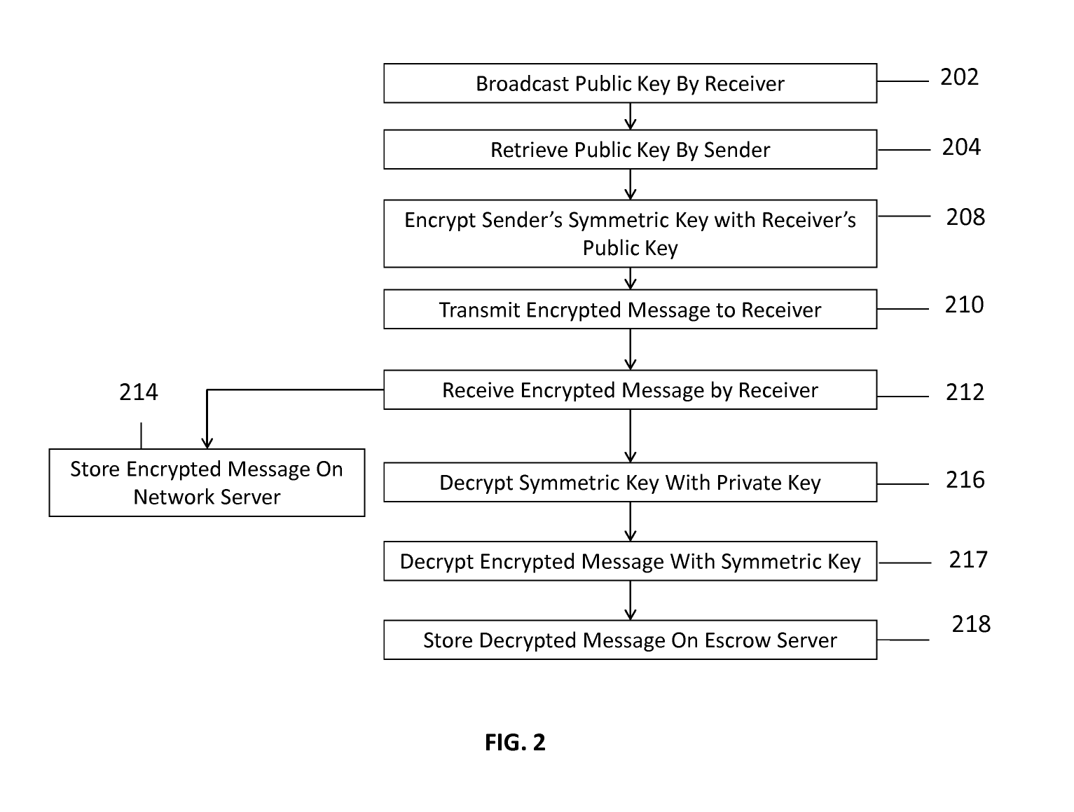

Referring now to FIG. 2, the receiver 104 broadcasts or transmits the public key 108 to a selected audience in step 202. The sender 102 retrieves the receiver 104's public key 108 in step 204. The sender 102 encrypts the symmetric key 107 by using the public key 108 of the receiver 104 in step 208. According to one aspect of the present invention, the sender 102 embeds the encrypted symmetric key 107 into a second image using steganography prior to transmitting the message to the receiver 104. According to a further aspect of the present invention, the sender 102 does not embed the encrypted symmetric key 107 into an image prior to transmitting the message to the receiver 104; the sender 102 transmitting the encrypted symmetric key 107 directly to the receiver 104 without embedding it in an image. The sender 102 transmits the communication including the encrypted symmetric key 107 to the receiver 104 in step 210 over the network 105. The receiver 104 receives the encrypted communication from the sender 102 in step 212. The receiver 104 includes the private key 110. The receiver 104 uses the private key 110 to decrypt the symmetric key 107 in step 216. The receiver 104 uses the symmetric key 107 shared between the sender 102 and the receiver 104 to decrypt communications from the sender 102 in step 217. The receiver 104 uses the symmetric key 107 to encrypt future communications from the receiver 104 to other devices within the network 105 that have received or possess the symmetric key 107.

The type of symmetric key 107 may be configured or selected based on preference and needs. The type of symmetric key 107 that is generated is based on a selected key generation service. The symmetic key 107 is an Advanced Encryption Standard (AES) 256 key, 128 bit AES, 256 bit AES, 256 bit TWOFISH, and the like.

The network, such as the unsecure network 105, within which the sender 102 and the receiver 104 communicate may include the network server 112 where the encrypted messages are stored in step 214.

In a further aspect of the present invention, the receiving device 104 includes a user interface for communicating the decrypted message to a user of the receiving device 104. The decrypted messages and keys are stored in step 218 on an escrow server 116.

According to a further aspect of the present invention, the client devices (such as the sender 102 and the receiver 104) are configured to allow for complete erasure or “zeroization” of all the keys sent or received by any user (sender 102, receiver 104, and other users or devices in the network). This aspect is particularly useful in case of loss or compromise of the device associated with the sender 102, the receiver 104, or any other device that has sent or received private messages or received the symmetric key 107. According to one aspect of the present invention, the keys are deleted to an un-restorable state.

The system 100 is configured to work seamlessly with several third party networking services, including TWITTER. The system 100 is configured to allow the users of the sender 102 and the receiver 104 to sign into the application for securely communicating in a network with their TWITTER (or other networking service) user names and passwords. The users are able to manage their account settings in the same manner as they would usually be able to with their TWITTER accounts. The TWITTER functionality and settings are directly accessible from within the application on the devices associated with the sender 102 and the receiver 104.

The system 100 may be used in any circumstance or industry where two or more people need to share information in a private and confidential manner. The encryption software is configured to integrate into any third party communication platform for any industry or service as needed by the users. The systems 100 and 101 may be used in the medical, legal, financial, real estate, architectural, entertainment and lifestyle, media, security, education, clergy, military, food and drug, law enforcement, intelligence community, private investigation services, political campaigns, government, and other fields and industries to securely transmit information to an intended audience. The systems 100 and 101 may be used in the medical profession for secure and confidential communications between doctor and patient; in the legal profession for secure and confidential communications between lawyer and client; in the military to securely and timely share information or plans with remote or disparate users; in the context of research and development for any company to enable it to securely share information.

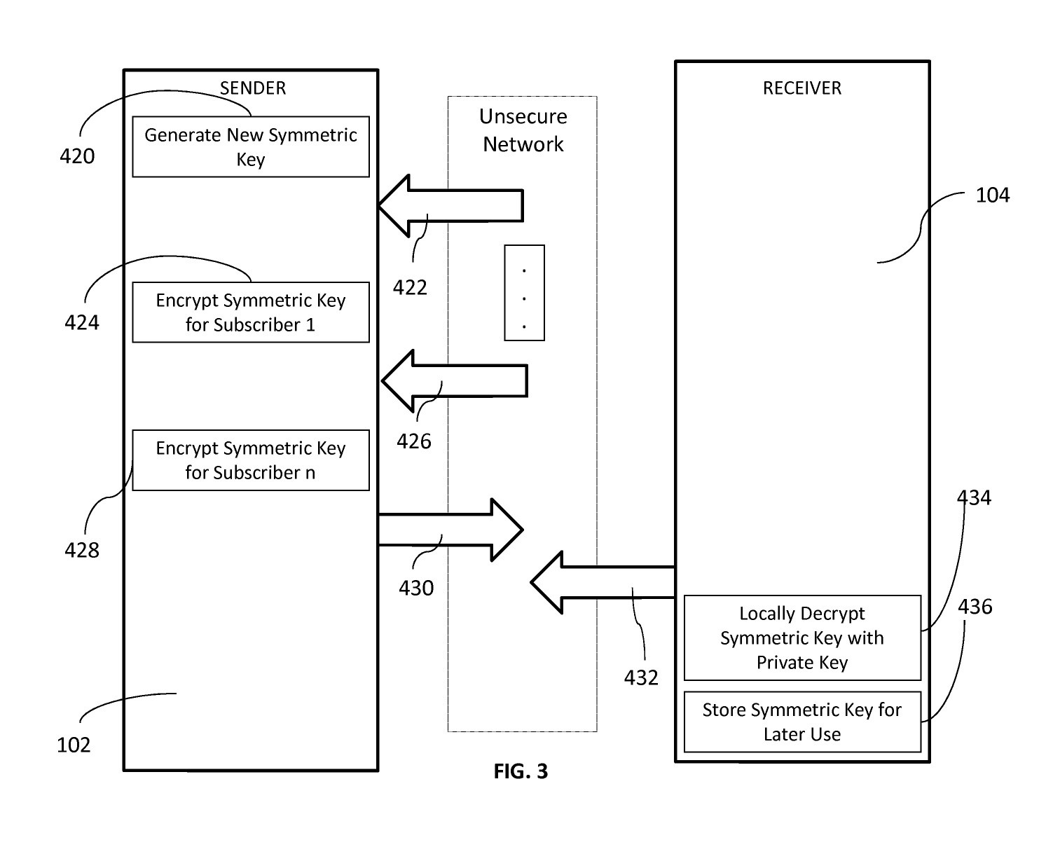

Referring now to FIG. 3, a subscription key model is illustrated. Clients or devices using the system for establishing secure communications according to the present invention may subscribe to other client's keys. Subscription is an exchange that occurs between users during a key exchange described in relation to FIGS. 1A and 1B. In order for the sender 102 to transmit secure data to the receiver 104, the receiver 104 must have the sender 102's symmetric key 107. As discussed above, the sender 102 encrypts the sender 102's symmetric key 107 with the receiver 104's public key 108 in step 208. The receiver 104 is configured to request to subscribe to the symmetric key 107 associated with the sender. The sender 102 is configured to allow or deny the subscription request, or to simply give the receiver 104 the current symmetric key 107 and no other keys. The sender 102 is configured to roll over its symmetric key 107 over based on a predetermined criterion (such as expiration date) or by choosing to do so manually. According to one aspect of the present invention, in order for the sender 102 to transmit secure data to the receiver 104, the receiver 104 must have the sender 102's symmetric key 107. The receiver 104 may specifically request the symmetric key 107 associated with the sender 102 or the sender 102 may transmit to the receiver 104 the symmetric key 107 at any time based on a predetermined set of criteria.

When the sender 102 rolls its symmetric key 107 over, the new symmetric key 107 is encrypted (with a public key) separately for each registered subscriber. The sender 102 generates a new symmetric key 107 in step 420. According to one aspect of the present invention, the sender 102 transmits a request or query to the key management service 118 indicating that the sender 102 would like to receive a new symmetric key 107. The key management service 118 transmits a request to the key source 114 to generate a new symmetric key 107 for the sender 102. The key source 114 generates a new symmetric key 107. The key source 114 retrieves a public key associated with the sender 102. The key source 114 encrypts the new symmetric key 107 with the public key associated with the sender 102. The key source 114 then transmits the encrypted symmetric key 107 to the key management service 118. The key management service 118 transmits the new symmetric key 107 to the sender 102.

The sender 102 retrieves a first subscriber's public key 108 in step 422. According to one aspect of the present invention, the public key 108 is steganographically embedded into an image associated with and broadcast by the first subscriber (such as the image 106 associated with the receiver 104). According to a further aspect of the present invention, the first subscriber's public key 108 is stored on a public or private cloud. Selected users have access to the public key 108 stored on the public or private cloud. According to a further aspect of the present invention, the sender 102 transmits a specific request to receive the first subscriber's public key 108 or the first subscriber transmits the public key 108 to the sender 102 based on a predetermined criterion or trigger.

The sender 102 encrypts the new symmetric key 107 with the first subscriber's public key 108 for the first subscriber. This encryption is carried out using the public key 108 of the first subscriber (such as the receiver 104). If there are multiple users or devices that subscribe to the sender 102's keys, the sender 102 retrieves a subsequent subscriber's (e.g., subscriber “n”) public key in step 426. The sender 102 encrypts the symmetric key 107 for each subsequent subscriber with that subscriber's public key 108 in step 428.

The sender 102 transmits or publishes a bundle of encrypted symmetric keys to the network 105 in step 430. According to one aspect of the present invention, the sender 102 transmits or publishes the bundle of encrypted symmetric keys by transmitting an image including the steganographically embedded encrypted symmetric key bundle. According to a further aspect of the present invention, the sender 102 transmits the bundle of encrypted symmetric keys to the key management service 118 for download by the receiving devices in the network 105. Each receiver in the network (such as the receiving device 104) downloads his own corresponding encrypted symmetric key 107. The bundle includes several encrypted keys, with a unique key being provided for each subscriber. Each subscriber checks the transmitted or published bundle for a personal encrypted symmetric key. The personal symmetric key for a given subscriber is encrypted with that subscriber's public key. Each subscriber retrieves the personal encrypted symmetric key in step 432. Each subscriber locally decrypts the encoded symmetric key with each subscriber's unique private key 110 in step 434. Each subscriber stores the decrypted symmetric key for subsequent usage in step 436.

According to one aspect of the present invention, the sender 102 is configured to broadcast only a single message or image including the bundle of encrypted symmetric keys 107. A separate message or image including steganographically embedded encrypted symmetric key does not need to be transmitted to each user, which significantly reduces the strain on the network 105.

According to one embodiment of the present invention, each one of the sender 102 and the receiver 104 is coupled to the key source 114. The key source 114 includes processing hardware configured to generate the symmetric key 107 and to roll over the symmetric key 107 based on predetermined criteria including passage of time and specific request by a network device. When the key source 114 rolls over the symmetric key 107, the key source 114 is configured to determine which devices in the network 105 subscribe to the symmetric key 107. The key source 114 is configured to retrieve the public keys associated with the devices in the network 105 that subscribe to the symmetric key 107. The key source 114 includes processing hardware configured to encrypt the symmetric key 107 with the public key associated with each device in the network that subscribes to the symmetric key 107. Accordingly, the key source 114 encrypts the symmetric key 107 individually for each subscriber with that subscriber's public key. The key source 114 combines all the encrypted symmetric keys 107 into a single message or bundle. According to one aspect of the present invention, the key source 114 transmits the bundle directly to the network 105, such that each subscriber can download and decrypt their own corresponding encrypted symmetric key 107. The corresponding encrypted symmetric key 107 is a symmetric key encrypted with the public key corresponding to the particular subscriber device. According to a further aspect of the present invention, the key source 114 includes processing hardware configured to steganographically embed the bundle of encrypted symmetric key 107 into an image. The key source 114 transmits or broadcasts the image to the network 105. Each subscriber then searches the image for their corresponding encrypted symmetric key 107. Each subscriber then decrypts the encrypted symmetric key with their own private key (e.g., private key 110 of the receiver 104).

The following discussion is intended to provide a brief, general description of suitable computer processing environments in which the methods and apparatus described herein may be implemented. In one non-limiting example, the method and apparatus will be described in the general context of processor-executable instructions, such as program modules, being executed in a distributed computing environment in which tasks may be performed by remote and local processing devices linked via one or more networks. Those of ordinary skill in the art will appreciate that the method may be practiced with any number of suitable computer system configurations and is not limited to the described configurations.

The present invention includes systems having processors to provide various functionality to process information, and to determine results based on inputs. Generally, the processing may be achieved with a combination of hardware and software elements. The hardware aspects may include combinations of operatively coupled hardware components including microprocessors, logical circuitry, communication/networking ports, digital filters, memory, or logical circuitry. The processors may be adapted to perform operations specified by a computer-executable code, which may be stored on a computer readable medium.

The steps of the methods described herein may be achieved via an appropriate programmable processing device, such as an external conventional computer or an on-board field programmable gate array (FPGA) or digital signal processor (DSP), that executes software, or stored instructions. In general, physical processors and/or machines employed by embodiments of the present invention for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments of the present invention, as is appreciated by those skilled in the computer and software arts. Appropriate software can be readily prepared by programmers of ordinary skill based on the teachings of the exemplary embodiments, as is appreciated by those skilled in the software arts. In addition, the devices and subsystems of the exemplary embodiments can be implemented by the preparation of application-specific integrated circuits or by interconnecting an appropriate network of conventional component circuits, as is appreciated by those skilled in the electrical arts. Thus, the exemplary embodiments are not limited to any specific combination of hardware circuitry and/or software.

Stored on any one or on a combination of computer readable media, the exemplary embodiments of the present invention may include software for controlling the devices and subsystems of the exemplary embodiments, for driving the devices and subsystems of the exemplary embodiments, for processing data and signals, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementations. Computer code devices of the exemplary embodiments of the present invention can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present invention can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of the invention as defined in the appended claims.

1. A receiving device for receiving secure communications, comprising:
a signal interface for receiving an image, the image including a steganographically embedded symmetric key from the sender, the symmetric key being encrypted with a public key associated with the receiving device; and
processing hardware configured to decrypt the symmetric key with a private key stored on the receiving device and to further secure communications with the sender via the symmetric key, wherein the processing hardware is further configured to encrypt future communications from the receiving device using the symmetric key.

2. The receiving device of claim 1, wherein the receiving device includes a second image associated therewith, the second image including a steganographically embedded public key, the sender being configured to extract the public key from the second image.

3. The receiving device of claim 1, wherein the receiving device communicates via a third party service wherein each transmission comprising text only is limited to 140 characters.

4. The receiving device of claim 1, wherein the receiving device and the sender communicate within an infrastructure, wherein the keys transmitted in the image are opaque to the infrastructure.

5. The receiving device of claim 4, wherein subsequent communications between the receiving device and the sender are encrypted with the symmetric key.

6. The receiving device of claim 1, wherein the receiving device and the sender communicate via a third party service and wherein each message between the receiving device and the sender is stored on a third party network server associated with the third party service in an encrypted form.

7. The receiving device of claim 4, wherein each communication between the receiving device and the sender is stored in a decrypted form on a secure escrow server.

8. The receiving device of claim 1, wherein the processing hardware is configured to delete the symmetric key, which renders each communication encrypted with the symmetric key unreadable.

9. The receiving device of claim 1, wherein the public key is a PKI key and the private key is an AES key.

10. A sending device for sending secure messages, comprising:
processing hardware configured to encrypt a symmetric key associated with the sending device with a public key associated with a receiving device and to steganographically embed the symmetric key into an image; and
a signal interface configured to send the image to the receiving device, wherein the symmetric key is decryptable by a private key associated with the receiving device.

11. The sending device of claim 10, wherein the processing hardware is configured to extract the public key from a second image associated with the receiving device.

12. The sending device of claim 10, wherein the public key is a PKI key and the symmetric key is an AES key.

13. The sending device of claim 10, wherein the processing hardware is configured to delete the private key and the symmetric key, which renders each communication encrypted with the symmetric key unreadable.

14. The sending device of claim 10, wherein the sending device communicates via a third party service wherein each communication comprising text only is limited to 140 characters.

15. The sending device of claim 10, wherein the receiving device and the sender communicate within an infrastructure, wherein the keys transmitted in the image are opaque to the infrastructure.

16. The sending device of claim 15, wherein subsequent communications between the receiving device and the sending device are encrypted with the symmetric key.

17. The sending device of claim 10, wherein the receiving device and the sending device communicate via a third party service and wherein each communication between the receiving device and the sending device is stored on a third party network server associated with the third party service in an encrypted form.

18. A system for securely communicating over a non-secure network, comprising:
a sending device including:
first processing hardware configured to encrypt a symmetric key associated with the sending device with a public key associated with a receiving device and to steganographically embed the symmetric key into an image; and
a first signal interface configured to the image to the receiving device; and
a receiving device including:
a second signal interface for receiving the image from the sending device; and
second processing hardware configured to decrypt the symmetric key with a private key stored on the receiving device and to further secure communications with the sender via the symmetric key.

19. The system of claim 18, wherein the network is a public third party social service.

20. The system of claim 19, wherein each communication transmitted between the sending device and the receiving device comprising only text transmitted within the public third party social service is limited to 140 characters.

21. The system of claim 19, wherein the third party service includes an electronic message retention server, the message retention server being configured to store only an encrypted version of each communication between the sending device and the receiving device, the decrypted content of the communication being inaccessible to the message retention server.

22. The system of claim 18, wherein each communication between the sending device and the receiving device is stored in a decrypted state on a secure escrow server.

23. The system of claim 18, wherein the sending device is configured to allow other devices within the network to subscribe to the symmetric key associated with the sending device and wherein the first processing hardware is configured to update the symmetric key based on predetermined criteria, including time and user request.

24. The system of claim 18, wherein the receiving device includes a second image associated therewith, the second image including the public key steganographically embedded into the second image, wherein the first processing hardware is configured to retrieve the public key from the second image.

25. A system for securely communicating in a network, comprising:
a sending device including:
first processing hardware configured to encrypt a symmetric key associated with the sending device with a public key associated with a receiving device; and
a first signal interface configured to send the encrypted symmetric key to the receiving device; and
a receiving device including:
a second signal interface for receiving the encrypted symmetric key from the sending device; and
second processing hardware configured to decrypt the symmetric key with a private key stored on the receiving device and to further secure communications with the sender via the symmetric key.

26. The system of claim 25, wherein each communication between the sending device and the receiving device is stored in a decrypted state on a secure escrow server.

27. The system of claim 25, wherein the sending device is configured to allow other devices within the network to subscribe to the symmetric key associated with the sending device.

28. The system of claim 25, wherein the first processing hardware is configured to update the symmetric key based on predetermined criteria, including time and user request.

29. The system of claim 25, further comprising a key source coupled to the sending device, the key source being configured to generate the symmetric key,

30. The system of claim 25, wherein the sending device includes a second public key associated therewith and wherein the system further comprises a key source, the key source being configured to:
generate the symmetric key;
to retrieve the second public key;
to encrypt the symmetric key with the second public key; and
to transmit the symmetric key encrypted with the second public key to the sending device.
